(19) United States
(12) Patent Application Publication
(10) Pub. No.: US 2014/0223418 A1
(43) Pub. Date: Aug. 7, 2014

(54) PERFORMANCE DATA IN VIRTUAL SERVICES

(71) Applicant: CA, INC., Islandia, NY (US)

(72) Inventors: John J. Michelsen, Arlington, TX (US); James Stephen Kress, Double Oak, TX (US); Christopher C. Kraus, Dallas, TX (US)

(73) Assignee: CA, INC., Islandia, NY (US)

(21) Appl. No.: 13/757,784

(22) Filed: Feb. 2, 2013

(51) Int. Cl. G06F 11/36

(52) U.S. Cl. CPC G06F 11/3668
USPC 717/135

(57) ABSTRACT

Performance data is accessed that describes a response time of a first software component to a particular request of another software component. A virtual service is instantiated to simulate operation of the first software component. In some instances, the virtual service can be instantiated based on a service model. The virtual service uses the performance data to generate responses to requests received from a second software component based on the performance data.

### BACKGROUND

The present disclosure relates in general to the field of computer testing, and more specifically, to testing involving a constrained system that may not always be available for use during testing.

As software becomes more sophisticated, it becomes more difficult to quickly and easily perform thorough software testing. In some instances, a particular program or application can interoperate with and be dependent on other programs or applications. However, in instances whether the other programs or applications are not under the control of the entity controlling the particular program or application or otherwise constrained, such other programs and applications may not be available to the entity when testing of the particular program or application is desired. For example, an airline may be reluctant to test a new reservation application or client against the airline's live production database in order to avoid negatively impacting (e.g., in terms of database record values or database response time) actual consumer transactions that will be taking place at the same time as testing. Similarly, in order to reduce costs, a financial institution may wish to minimize interactions between a new credit card application system and a partner service due to per-transaction fees, such as those that are charged for each credit check, charged by the partner service. In yet another example, the constrained service may still be in development and thus not yet available to interact with the application under test.

### BRIEF SUMMARY

According to one aspect of the present disclosure, performance data can be accessed that describes a response time of a first software component to a particular request of another software component. A virtual service can be instantiated to simulate operation of the first software component. In some instances, the virtual service can be instantiated based on a service model. The virtual service can use the performance data to generate responses to requests received from a second software component based on the performance data.

### BRIEF DESCRIPTION OF THE DRAWINGS

FIG. 1 is a simplified schematic diagram of an example computing system including an example virtual service system in accordance with at least one embodiment;

FIG. 2 is a simplified block diagram of an example computing system including an example virtualization engine and a performance monitor in accordance with at least one embodiment;

FIG. 3 is a simplified block diagram illustrating an example service model in accordance with at least one embodiment;

FIG. 4 is a simplified block diagram illustrating aspect of another example service model in accordance with at least one embodiment;

FIG. 5 is a flow diagram illustrating example monitoring of transactions involving two or more software components in accordance with at least one embodiment;

FIGS. 6A-6D are simplified block diagrams illustrating example actions involving virtualization of a software component in accordance with at least one embodiment;

FIG. 7 is a graph illustrating an example set of response times of an example software component over a period of time; and

FIGS. 8A-8B are simplified flowcharts illustrating example techniques in connection with virtualization of a software component in accordance with at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

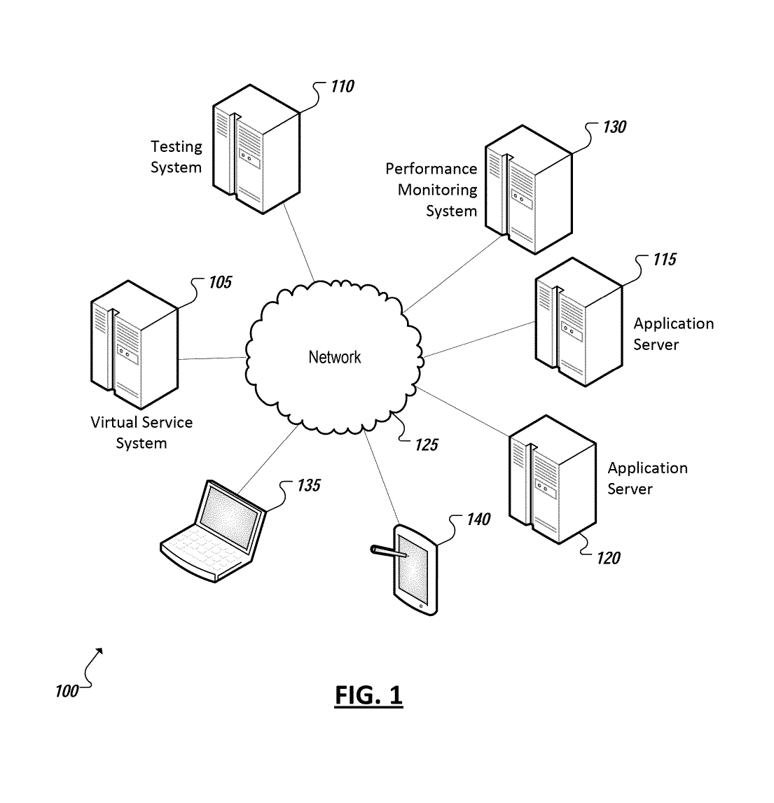

Referring now to FIG. 1, FIG. 1 is a simplified block diagram illustrating an example computing environment 100 including a virtual service system 105 and a testing system 110. Virtual services can be generated and maintained using virtual service system 105 that model and simulate operation of one or more software components within a test, development, educational, training, or other environment, such as test environment provided using testing system 110. Such virtual services can model software component hosted, for instance, by one or more application servers (e.g., 115, 120) or other systems, including software components interoperating and communicating with other software components over one or more networks 125, including the Internet, private networks, and so on.

In some implementations, a virtual service can model software components not readily available for use with another software component upon which the other software component depends. For instance, the use of or access to a particular software component modeled by a corresponding virtual service may be desirable in connection with testing or development of the other software component. Where the particular software component is not available (or it not desirable to utilize the actual particular software component) a corresponding virtual service can possess functionality allowing the virtual service to effectively stand in for the particular software component.

In some implementations, a particular virtual service can not only possess functionality for modeling and simulating the operations of the modeled software component, but the particular virtual service can possess functionality allowing the virtual service to also model how the modeled software component would behave in actual operation. For instance, real world software components can impose delays in a transaction in connection with internal processing and operations of the software component and the generating of responses (e.g., based on such processing and operations) to requests of the modeled software component. Accordingly, in some implementations, a virtual service generated by virtual service system 105 can possess functionality for modeling real world performance of the modeled software component including response times of the modeled software component. Further, in some implementations, a virtual service can consume performance data provided and/or generated, for instance, by one or more performance monitoring systems or devices (e.g., 130) that describe real world performance and operation of the modeled software component as the basis of modeling performance of the modeled software component, among other examples.

In some implementations, one or more user devices (e.g., 135, 140) can be included in computing environment 100 allowing one or more users to interact with and direct operation of one or more of virtual service system 105, testing system 110, performance monitoring system 130, application servers 115, 120, etc., provided, in some instances, as services hosted remote from the user device (e.g., 135, 140) and accessed by the user device (e.g., 135, 140) using one or more networks (e.g., 125), among other examples.

In general, “servers,” “clients,” “computing devices,” “network elements,” “hosts,” “system-type system entities,” “user devices,” and “systems,” etc. (e.g., 105, 110, 115, 120, 130, 135, 140, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 110, 115, 120, 130, 135, 140, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, a virtual service system 105, testing system 110, performance monitoring system 130, application server (e.g., 115, 120), or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

In some forms of software testing, software components (such as particular programs, applications, objects, modules, database management system, etc.) can be tested not only to identify whether the software component performs as expected under ideal conditions, but also under duress or when faced with less than ideal (e.g., real-world conditions). Such testing can include integration testing and/or load testing of the software component, among other examples. In some instances, responsiveness of a particular software component can be dependent on a variety of factors, including load on the particular software component, load experienced by another software component upon which the particular software component depends, the type and size of requests or transactions handled by the particular software component, among other examples. In modern systems, software components (e.g., clients) can consume services provided by another software component (e.g., servers). In some instances, a client component's performance and operation can be impacted by performance and delays of the server component upon which it relies. Accordingly, in such instances, it can be advantageous, for example, to test the client component against a variety of different performance conditions of the server component. For instance, a client component can be tested against a server component experiencing a variety of different loads, at different times of day, on various dates (e.g., last Tuesday vs. Cyber Monday), among other examples to identify how variations in the performance quality of the server component influences performance of the client component, among other examples.

Virtual services can be used, in some implementations, to model performance and operation of a server component, among other potential uses. In some instances, it can be impractical or even impossible to perform a series of tests against a live version of a server component corresponding to each of the variety of conditions that a server component might face. Accordingly, rather than performing a test (e.g., of a client component) against the actual server component, the test can be performed utilizing a virtual service of the server component and the virtual service can model various performance characteristics of the server component, such as the response times of the server component, including varied response times corresponding to particular conditions or loads experienced by the server component, among other examples. Further, as noted above, a virtual service may also be advantageous to use when access to or tests using the server component is constrained, among many other potential advantages.

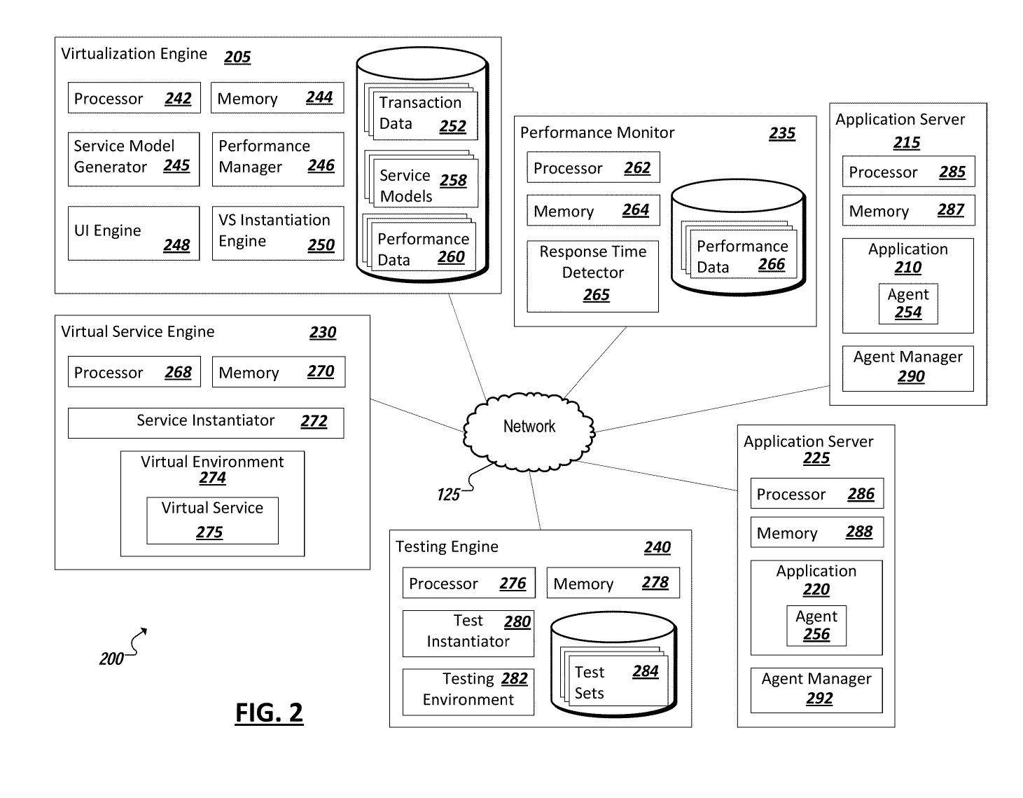

At least some of the systems described in the present disclosure, such as the systems of FIGS. 1 and 2, can include functionality providing at least some of the above-described as features that, in some cases, at least partially remedies or otherwise addresses at least some of the above-discussed issues, as well as others not explicitly described herein. For instance, turning to the example of FIG. 2, a simplified block diagram 200 is shown illustrating an example environment including a virtualization engine 205 adapted to generate service models that can be deployed as virtual services modeling one or more applications (e.g., application 210 hosted by application server 215, application 220 hosted by application server 225, etc.). A virtual service engine 230 can also be provided through which the virtual service can be instantiated. Additionally, performance data provided by a performance monitor can, in some examples, be utilized by an instantiated virtual service to model real world performance characteristics of a modeled application. Such virtual services can be used, for instance, in a test, facilitated using a testing engine 240, among other examples.

An example virtualization engine 205 can include, in some implementations, one or more processor devices (e.g., 242), one or more memory devices (e.g., 244), and other hardware and software components including, for instance, service model generator 245, a performance data manager 246, a user interface (UI) engine 248, and virtual service instantiation engine 250, among other example components, including components exhibiting other functionality or components combining functionality of two or more of the above components, among other examples. A virtualization engine 205 can be used to generate and manage virtual services. Service models 258 can be generated, in some implementations, for processing by a virtual service engine 230 (using, for instance, a service instantiator 272) to construct a virtual service (e.g., 275) from the service model 258 data. The virtual service 275 can be executed and hosted within a virtual service environment 274, such as a virtual service environment implemented using one or more virtual machines or another environment. A virtual service engine 230 can include one or more processor devices 268 and memory elements 270 among other software and hardware components. In some implementations, functionality of virtual service engine 230 can be combined with or included in functionality of the virtualization engine 205. For instance, in some implementations, virtualization engine 205 can both construct service models 258 as well as instantiate virtual services (e.g., 275) from the service models 258, among other potential implementations that may be used in the generation of virtual services.

In one example, service models 258 can be generated by virtualization engine 205 (e.g., using service model generator 245) based on detected requests and responses exchanged between two or more software components or systems (such as applications 210 and 220). Such request and response information can be captured, for instance, by agents (e.g., 254, 256) capable of monitoring a software component that is to be virtualized or that interacts with another software component to be virtualized, among other examples. Data describing such requests and responses, as well as characteristics of the requests and responses, can be embodied, for example, in transaction data 252. In some implementations, service model generator 245 can build service models 258 from transaction data 252.

In one particular example, a service model generator 245 can generate and store information in service models 258 identifying one or more characteristics of the transactions described in transaction data 252. Such information can include timing information identifying times at which particular requests and/or responses are detected or sent (e.g., in order to identify the delay between when the request was detected and/or sent and when the associated response was detected and/or sent), information identifying current bandwidth usage of a network on which the traffic is being conveyed, information identifying current processor and/or memory usage on one or both of the computing devices implementing a corresponding requester software component and server software component, and the like. Virtual services instantiated from such service models can embody the performance characteristics captured or defined in the service model, including response times, network bandwidth characteristics, processor usage, etc. Such service models may be limited, however, in the variety of performance characteristics that can be observed on the software components they are meant to model, with the service model based, in some implementations, on that subset of transactions (and the performance characteristics identified from these transactions) from which the service model was generated. Accordingly, additional performance data 260 can be provided and used in a virtual service to supplement or even override these “default” performance characteristics defined in the service model. For instance, performance data 260, when provided for use by a virtual service can at least partially override information included in the service model and cause the virtual service to at least partially deviate from the default performance characteristics defined in the service model, among other examples. In this sense, the functionality and attributes of virtual services can be enhanced or modified, in some cases dynamically at runtime, based on performance data 260 provided for use by the virtual service.

In one example, a service model generator 245 can be configured to identify requests and responses, from transaction data 252, in each of a variety of different protocols and to extract and record the pertinent information from each. Thus, service model generator 245 can include configuration information identifying the basic structure of requests and responses for each of several supported communication protocols. When generating service models 258, service model generator 245 can access the appropriate configuration information in order to process the observed traffic. Depending upon the protocol in use, for instance, requests can take the form of method calls to an object, queue and topic-type messages (e.g., such as those used in Java messaging service (JMS)), requests to access one or more web pages or web services, database queries (e.g., to a structured query language (SQL) or Java database connectivity (JDBC) application programming interface (API)), packets or other communications being sent to a network socket, and the like. Similarly, responses can include values generated by invoking a method of an object, responsive messages, web pages, data, state values (e.g., true or false), and the like.

Transaction data 252 can be collected from one or more monitoring tools (e.g., agents 254, 256) configured to be logically inserted within a communication pathway between a transacting client (or requester) component and a server (or responding) component. Transaction data can also be obtained through other monitoring techniques, including the monitoring of appropriate queue(s) and topics for new messages being exchanged between a requester component and responding component communicating via messaging, intercepting method calls to a particular server component (e.g., object), and so on. Further, monitoring tools can also intercept responses from the responding software component and corresponding information in transaction data 252 can be generated that identifies those responses as corresponding to requests of a particular requester component, among other examples.

Transaction data 252 can further document attributes of requests and responses detected within a particular transaction. For example, a request can include an operation and one or more attributes. As an example, transaction data can identify a command to perform a login operation as well as attributes that include the user name and password to be used in the login operation. Accordingly, service model generator 245 can also parse requests identified in transaction data 252 in order to identify whether any attributes are present and, if so, to extract and store information identifying those attributes. Thus, information identifying a request in a corresponding service model (e.g., 258) can include information identifying a command as well as information identifying any attributes present within the request. Similarly, for responses, a service model generator 245 can parse transaction data to identify responses and response attributes (e.g., using protocol-specific configuration information in order to determine how to locate the attributes within the response) and incorporate such information in service models identifying the response.

Service models 258 can be used as the basis of virtual services modeling the software components providing the requests and/or responses modeled in the service models 258. Virtual services can capture and simulate the behavior, data and performance characteristics of complete composite application environments, making them available for development and testing at the request of a user or system and throughout the software lifecycle, among other advantages. In some instances, a virtualization engine 205 can include functionality for the creation of complete software-based environments using virtual services that simulate observed behaviors, stateful transactions and performance scenarios implemented by one or more software components or applications. Such virtual services provide functionality beyond traditional piecemeal responders or stubs, through logic permitting the recognition of input/requests and generation of outputs/responses that are stateful, aware of time, date, and latency characteristics, support such transaction features as sessions, SSL, authentication, and support string-based and dynamic request/response pairs, among other features. Service virtualization and other virtual models can be leveraged, for instance, when live systems are not available due to project scheduling or access concerns. In cases where components have not been built yet, environments can employ virtual services to rapidly model and simulate at least some of the software components to be tested within an environment. Virtual services can be invoked and executed in a virtual environment 274 implemented, for instance, within on-premise computing environments, in private and public cloud-based lab, using virtual machines, traditional operating systems, and other environments, among other examples. In some implementations, virtualization system 205 and virtual services (e.g., 274) and other supporting components can utilize or adopt principles described, for example, in U.S. patent application Ser. No. 13/341,650 entitled “Service Modeling and Virtualization,” incorporated herein by reference in its entirety as if completely and fully set forth herein.

As noted above, in some implementations, virtual services can model not only responses to various requests by a client software component but can additionally model the performance of a server software component. Such performance characteristics can include the time that the server software component takes to generate and send a response, among other examples. In one example, virtualization engine 205 can include a performance data manager 246 that can be utilized to provide performance data for consumption in connection with the provision of a particular virtual service. While shown as a component of virtualization engine 205, in other instances, performance manager 246 can be implemented in a virtual service engine or other system adapted to instantiate a corresponding virtual service and provide a virtual environment 274 for the virtual service's (e.g., 275) execution. Performance data 260 corresponding to a software component modeled by a particular virtual service (and underlying service model) can be incorporated into the instantiation of the virtual service to provide the virtual service with the capability of generating responses in accordance with the performance data 260 describing characteristics of the modeled component's operation. In other instances, an instantiated virtual service can include functionality for accessing and utilizing various performance data, including performance data hosted outside of a virtual environment, among other potential implementations. Regardless of the implementation, a virtual service can make use of information included in performance data 260 and conform its operation to the performance characteristics described or identified in the performance data 260. A performance data manager 246 can facilitate such functionality by making relevant performance data 260 available for use in connection with execution of a corresponding virtual service.

In some instances, performance data manager 246 can include additional functionality for collecting performance data for a variety of different software components, including software component for which service models have already been generated, as well as software components for which service models are not yet available. Performance data 260 can be provided by and collected from a variety of sources. In some example systems, one or more performance monitors can monitor transactions of software components within a network or system. Such performance monitors (e.g., 235) can include one or more processors (e.g., 262) and one or more memory elements (e.g., 264) among other components. In some implementations, performance monitors 235 can include various sensors for collecting various data, including data that can be used to determine a response time of a particular software component (e.g., using response time detector 265). Other sensors can capture additional performance information such as network latency, packet size, time-out statistics, communication errors, processing errors of a software component, among other information corresponding to operational characteristics of a software component. Such performance information can be embodied in performance data 266 and can be provided to and used by virtual services to model such characteristics during execution of the virtual service, among other examples.

In some implementations, a performance monitor 235 can capture and generate performance data describing characteristics of multiple different software components, such as application 210 on application server 215 and application 220 on application server 225 communicating or transacting, for instance, over one or more networks (e.g., 125), such as the internet, a local private network, an enterprise network, among other examples. In some instances, monitors, scanners, or other tools local to the system hosting a software component can additionally (or alternatively) capture performance data describing performance of a software component. In some examples, software components or the systems hosting the software components can be instrumented with agents (e.g., 254, 256) that can capture requests and responses sent or received by a particular software component and can further include functionality for discovering performance characteristics and other features of the particular software component.

An application server (e.g., 215, 225) can include one or more processor devices (e.g., 285, 286), one or more memory elements (e.g., 287, 288), one or more software components (e.g., applications (e.g., 210, 220), one or more interfaces over which software components can communicate (including over network 125), as well as operating systems and environments for use in the execution of the software components, among other examples. In one example, an agent (e.g., 254, 256) can be provided that monitor applications 210, 220. Such agents can be dedicated agents in that they only monitor a single software component, or can be agents adapted to monitor multiple software components, etc. An agent manager (e.g., 290, 292) can be provided, in some cases, to communicate with agents (e.g., 254, 256) and collect data describing information collected by the agents. Further, in some implementations, agent managers 290, 292 can further interface with other systems or components, such as virtualization engine 205, testing engine 240, etc., and provide agent data from the agents (e.g., 254, 256). Such agent data can be used, for instance, as the basis of transaction data 252, among other examples. Further, in some implementations, agents (e.g., 254, 256) can communicate directly with such systems (e.g., 205, 240, etc.), such as through agent managers present on the systems (e.g., 205, 240) among other potential implementations.

Software systems (e.g., 215, 225) and their constituent software components (e.g., 210, 220) can include functionality for communicating with one or more other systems and components over one or more networks (e.g., 125), using one or more network ports, sockets, APIs, or other interfaces, among other examples. Some applications can include front-end, user-facing services and applications that further include user interfaces for presenting at least some of the outputs and results of a transaction to a user. Such user interfaces can further accept one or more inputs or request values provided by a user, among other examples. Applications, software systems, and software components can perform any variety of tasks or services and be implemented using potentially any suitable programming language, architecture, and format. Further, virtualization system 205, performance monitors 235, testing engine 240, etc. can be implemented so as to flexibly support analysis, virtualization, and testing of any variety of software systems, programming languages, architectures, and the like utilized by applications and software systems, among other examples.

In some examples, agents (e.g., 254, 256) deployed on or in connection with one or more applications (e.g., 210, 220), or other software components, can be software-implemented agents that are configured to provide visibility into the operations of each instrumented application (e.g., 210, 220, etc.) as well as, in some cases, the sub-components of the instrumented applications. Each agent can be configured, for example, to detect requests and responses being sent to and from the component or application in which that agent is embedded. Each agent (e.g., 254, 256) can be configured to generate information about the detected requests and/or responses and to report that information to other services and tools. Such information can be embodied as agent data. Additionally, each agent can be configured to detect and report on activity that occurs internal to the component in which the instrumentation agent is embedded. Agents can be implemented in a variety of ways, including instrumenting each component with a corresponding agent, instrumenting an application or other collection of the software components with a single, shared agent, among other examples.

In response to detecting a request, response, and/or other activity to be monitored, each agent (e.g., 254, 256) can be configured to detect one or more characteristics associated with that activity and/or the monitoring of that activity by the agent. The characteristics can include an identification of the requesting component that generated the request sent to the component or sub-component monitored by the instrumentation agent (or identification of the target component to which a request (or response) was sent by the monitored component). Agent data can further include a transaction identifier, identifying the transaction, with respect to the component or sub-component being monitored, such as transactions between components carried out through communications and calls made over one or more network connections; and an agent identifier that identifies the agent, with respect to the other instrumentation agents in the testing system, that is generating the characteristics, among other characteristics. Such characteristics can include other information such as a system clock value, current processor and/or memory usage, contents of the request, contents of the response to the request, identity of the requester that generated the request, identity of the responder generating the response to the request, Java virtual machine (JVM) statistics, standard query language (SQL) queries (SQLs), number of database rows returned in a response, logging information (e.g., messages logged in response to a request and/or response), error messages, simple object access protocol (SOAP) requests, values generated by the component that includes the instrumentation agent but that are not returned in the response to the request, web service invocations, method invocations (such as Enterprise Java Beans (EJB) method invocations), entity lifecycle events (such as EJB entity lifecycle events), heap sizing, identification of network connections involved in transactions, identification of messages and data exchanged between components, including the amount of such data, and the like. Characteristics can also include the thread name of a thread processing the request to generate the response and other data describing threads involved in a transaction, the class name of the class of an object invoked to process the request to generate the response, a Web Service signature used to contain the request and/or response, arguments provided as part of the request and/or response, a session identifier, an ordinal (e.g., relating to an order within a transaction), the duration of time spent processing the request and/or generating the response, state information, a local Internet Protocol (IP) address, a local port, a remote IP address, a remote port, and the like, among other examples.

Additionally, agents (e.g., 254, 256) can monitor and report characteristics independently for each transaction in which its respective monitored component(s) (e.g., 210, 220, etc.) participates. In addition to monitoring the performance of a component and aggregating information about that component over one or a multitude of transactions (such that information about the performance of individual transactions can, for example, be averaged or statistically assessed based upon the observed performance of the component over the course of multiple monitored transactions), agents (e.g., 254, 256) can additionally provide characteristics that are specific to and correlated with a specific transaction. More particularly, these characteristics that are monitored and reported by the agents can be specific to and correlated with a particular request and/or response generated as a part, or fragment, of a transaction.

In some embodiments, all or some of agents (e.g., 254, 256) can be configured to perform interception and/or inspection (e.g., using the Java™ Virtual Machine Tool Interface, or JVM TI). Such an instrumentation agent can register with the appropriate application programming agent (API) associated with the component or process being monitored in order to be notified when entry and/or exit points occur. This allows the agent to detect requests and responses, as well as the characteristics of those responses. In particular, this functionality can allow an agent to detect when a component begins reading and/or writing from and/or to a socket, to track how much data is accessed (e.g., read or written), obtain a copy of the data so read or written, and generate timing information (as well as information describing any other desired characteristics such as inbound/read or outbound/write identifiers) describing the time or order at which the data was read or written.

In some instances, agents (e.g., 254, 256) can be configured to monitor individual threads by monitoring the storage used by each thread (i.e., the thread local storage for that thread), among other information. Such agents can detect when the monitored thread begins reading or writing to a thread local variable in the thread local storage. In response to detecting this access to the thread local variable, the agent can track the amount (e.g., in bytes, as tracked by incrementing a counter) of data that has been accessed, as well as the starting offset within the thread local storage to which the access takes place. In response to detecting that the thread's access to the thread local variable has ended, the instrumentation agent can use the information about the access to identify characteristics such as the time of the access, the variable being accessed, the value being accessed, network calls being made, and the like.

As noted above, in some implementations, one of the characteristics that can be collected by agents (e.g., 254, 256) can include timing information, such as a timestamp, that indicates when a particular request was received or when a particular response was generated. Such timing information can be used, in some cases, to determine response times of a particular component. Additionally, any of the characteristics of a transaction or software component capable of being captured by an agent can be embodied in transaction data 252 or even performance data 260 for use, for instance, by virtualization engine 205 in the generation of virtual services.

In some implementations, agents (e.g., 254, 256) can be implemented by inserting a few lines of code into the software component (or the application server associated with that software component) being instrumented. Such code can be inserted into a servlet filter, SOAP filter, a web service handler, an EJB3 method call, a call to a Java Database Connectivity (JDBC) handler, and the like. For example, an agent configured to monitor an EJB can be configured as an EJB3 entity listener (e.g., to monitor entity beans) or interceptor (e.g., to monitor session beans). Some components (or their corresponding application servers) may not provide users with the ability to modify their code, and thus some instrumentation agents can be implemented externally to the component being monitored in a manner that can cause all requests and responses being sent to and/or from that component to be handled by the corresponding agent(s). For example, for an existing database, an agent can be implemented as a driver. Calling components can be configured (e.g., by manipulating a driver manager) to call the instrumentation driver instead of the database's driver. The instrumentation driver can in turn call the database's driver and cause the database's driver to return responses to the instrumentation driver. For example, in one embodiment, the identity of the “real” driver for the database can be embedded in the uniform resource locator (URL) that is passed to the instrumentation driver. In this way, the instrumentation driver can intercept all calls to the database, detect characteristics of those calls, pass the calls to the appropriate database, detect characteristics of the corresponding responses, and then return the characteristics of those calls and responses for inclusion, for instance, in transaction data 252, performance data 260, and other examples.

In some example implementations, a testing engine 240 can be used in connection with the execution of a virtual service. An example testing engine 240 include, for example, one or more processor devices (e.g., 276) and one or more memory elements (e.g., 278) for use in executing one or more components, tools, or modules, or engines, such as a test instantiator 280, testing environment 282, among other potential tools and components including combinations or further compartmentalization of the foregoing. Test instantiator 280 can be used to load one or more predefined test sets 284 that include, for instance, data for use in causing a particular software component under test to send a set of requests to a server software component. In some instances, the server software component (or server system hosting the server software component) can be replaced by one or more virtual services provided through virtualization engine 205. Test sets 284 can include additional instructions and data to cause the one or more virtual services to be automatically instantiated (e.g., using virtual service instantiation engine 250 and/or virtual service engine 230, etc.) for use in the test. Further, test sets 284 can also identify particular conditions to be applied in the tests of the particular software component, including the identification of particular performance characteristics (and corresponding performance data (e.g., 260)) to be used to model particular conditions within the test, among other examples. Accordingly, in such examples, a testing engine 240 can cause such performance data 260 to be selected and utilized in connection with a virtual service used in the test, among other examples and combinations of the above.

A virtualization engine 205 (or other system (e.g., testing engine 240)) can provide user interfaces (e.g., using UI engine 248) for presentation on user devices, such as personal computers, tablet computers, smart phones, and so on. A user, through such user interfaces, can further define performance characteristics to be applied at runtime of a virtual service. For instance, a user can select a particular test (e.g., from test sets 284) and consequently cause one or more virtual services and performance data to be loaded for use in the test. In another example, a user can explicitly select a particular virtual service to be instantiated. For instance, a user can select a particular software component to virtualize and virtual service instantiation engine 250 (or other element) can identify a corresponding service model 258 to be loaded for use in instantiating a corresponding virtual service modeling the particular software component selected by the user.

Further, user interfaces can be provided to allow users to define particular performance characteristics to be applied at the virtual service. For example, in one instance, a user can select particular performance data 260 to be used in connection with execution of a virtual service. In another example, a user can identify the performance characteristics of a particular software component they would like to model (e.g., the particular software component experiencing a particular load or range of loads, particular response times or response time ranges of the software component, etc.) and a performance data manager 246 (or other element) can identify corresponding performance data for use by a corresponding virtual service for the particular software component. In still another example, a user can select or define a particular period or span of time, such as a particular time of day, time range, date, date range, etc. of operation of a particular software component and the performance data manager 246 can identify performance data 260 collected during live operation of the particular software component during the specified times or time ranges for use with a virtual service modeling the particular software component, among other examples.

In some implementations, a user can custom-define a set of performance data corresponding to a scenario involving a particular software component. Such user-defined performance data can be implemented in a variety of forms, including a spreadsheet, parsable text, or other formats, and describe response times and ranges of response times to be used by a virtual service modeling the scenario. For example, a user, such as a test administrator, can define a custom set of performance data for a particular software component, software components of a particular type, or software components generally that models particular performance behavior of the software component. For instance, a set of performance data (whether user-generated or collected by one or more performance monitors (e.g., 235)) can identify the varying response times of a software component over a range of time, for instance, documenting how response times decrease and/or increase over the range of time (e.g., depending on the varying load or other conditions experienced by the software component during these times). User defined performance data sets can be included in performance data 260 and can also be selected for use with a virtual service that models performance and operation of a corresponding software component.

In some implementations, when a service model is used to instantiate a virtual service, the virtualization process can involve comparing new requests generated by a requester to the request information stored in a corresponding service model. For example, if a new request containing a particular command and attribute is received, the service model can be searched for a matching request that contains the same command and attribute. If a matching request is found, the virtualization process returns the response (as identified by information stored in service model) associated with the matching request to the requester.

In many situations, the requests provided to a virtual service will not be exactly the same (i.e., containing the same request as well as the same attribute(s)) as the requests identified in service model. For example, a request provided to the corresponding virtual service may contain the same request but a different attribute or set of attributes. A service model can further include information usable to handle these requests. For instance, transactions containing requests that specify the same command can be identified as being of the same transaction type. Alternatively, a set of transactions can be identified as being of the same type if all of those transactions have requests that include the same command as well as the same number and type of attributes. The particular technique used to identify whether two or more transactions are of the same type can be protocol specific, in some embodiments (e.g., classification of transactions can be at least partially dependent upon the particular communication protocol being used between the requester and the server).

For each unique type of transaction included in a service model, some implementations of a service model can further provide information or instructions for use by a virtual service in generating responses to requests with unknown attributes (e.g., an unknown attribute that was not observed as part of the monitored traffic or even specified by a user during a manual service model building process). Further, service models can also include information describing how to respond to an unknown request (e.g., a request that contains a command that was not observed as part of the monitored traffic). As an example, the request portion of this service model information can indicate (e.g., through the use of a wildcard command identifier) that all unknown types of requests that are not otherwise identified in service model should match this request. The response portion of the generated information can include an appropriate response, among other examples.

In addition to adding information describing unknown transactions of known and unknown types, some implementations of service models can support time sensitive responses. In such embodiments, response information in the server model can facilitate substitution of time sensitive attributes for actual observed attributes. For instance, an actual attribute “10:59 PM Oct. 1, 2009” can be replaced with a time sensitive value such as “[SYSTEM CLOCK+11 HOURS]”. When the service model is used to generate responses by the virtual service, the time sensitive value can be used to calculate the appropriate attribute to include in each response (e.g., based on the current system clock value). To illustrate, in this particular example, if the service model is being used by a virtual service and the response attribute includes the time sensitive value [SYSTEM CLOCK+11 HOURS], the response generated based upon the service model will include the value generated by adding 11 hours to the system clock value at the time the request was received. In general, time sensitive values specify an observable time, such as a time value included in a request or the current system clock time, and a delta, such as an amount of time to add or subtract from the specified observable time. Time sensitive values can be included in the response information for all types (known and unknown) of transactions.

In some implementations, a service model can further include information facilitating the use of request sensitive values to be included in responses generated by the virtual service using the service model. A request sensitive value can link an attribute included in the request to a value to be included in the response. For example, response information in a service model can indicate that a particular request attribute be used as the basis of a particular attribute of the response to be returned in response to the request.

When the model is used, the response generated by the virtualized service will include the value indicated by the request sensitive value. For example, the model can include three known transactions of a given transaction type, as well as one unknown transaction of that type. The information describing the unknown transaction can indicate that the single response attribute is a request sensitive attribute that should be the same as the first attribute of the request. A request of that type that contains an unknown first attribute (i.e., an attribute that does not match the attribute(s) stored for the three known transactions of that type in the model) can be sent to the virtualized service. In response to receiving this request and accessing the request sensitive value specified in the response information for the unknown transaction, the virtualized service returns a response that includes the value of the first attribute that was contained in the received response. As an example, if the information describing a known transaction of type A indicates that the request includes the string “UserID” as the first request attribute and that the corresponding response includes the string “UserID” as its second response attribute, a request sensitive value specifying “[REQUEST ATT 1]” (first request attribute) can be generated for the second response attribute in the service model, among many other potential examples, including more complex examples with more complex dependencies defined in the service model between certain request attribute and request sensitive response attributes.

A service model can include still additional information. For example, a service model can identify characteristics of each transaction in order to identify availability windows for a corresponding software component modeled by the service model, load patterns for the software component, and the like. For example, if an access window is identified for a particular type of transaction, a corresponding service model can be generated to include a characteristic indicating that a response (or a particular type of response) will only be generated if the request is received during the identified access window, among many other potential examples.

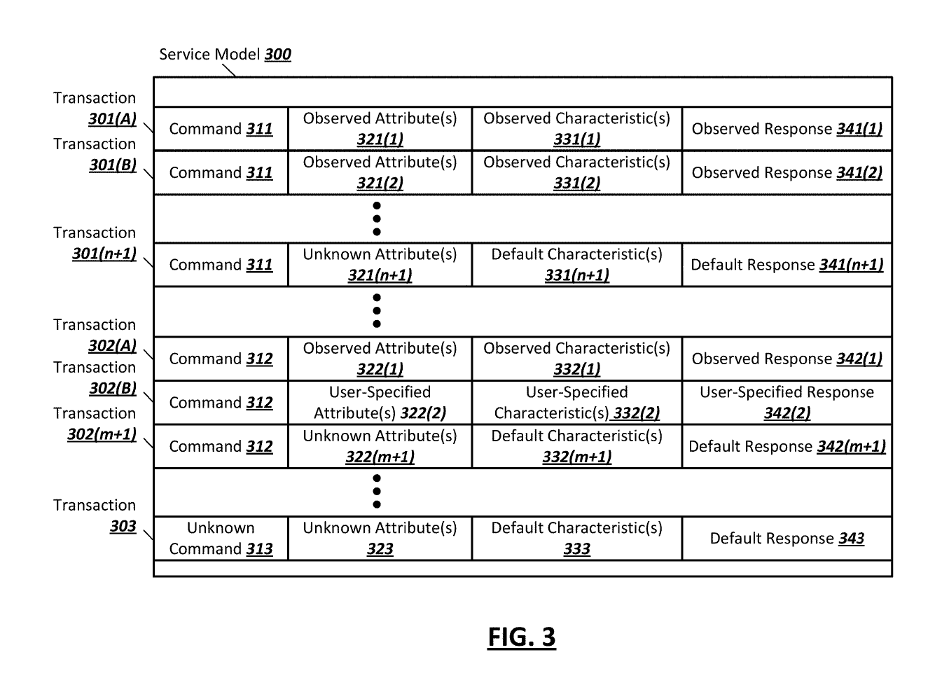

Turning to FIG. 3, a simplified block diagram is shown representing an example view of an example service model 300. For instance, FIG. 3 shows information that can be maintained as part of a service model. In this particular example, service model 300 can include a row for each of several transactions. Each row of service model 300 can identify a command, zero or more attributes, zero or more characteristics, and one or more response attributes. This service model can be stored in a spreadsheet, table, database, or any other data structure.

In this example, transaction 301(A) is an observed transaction. In other words, transaction 301(A) is a transaction that actually occurred between a requester and the server component being modeled, as detected, for instance, by an agent or other tool. The information describing transaction 301(A) can include request information, which includes command 311 and zero or more observed attributes 321(1). The information describing transaction 301(A) also includes response information 341(1) describing the observed response that corresponds to the observed request. This response information 341(1) can also include one or more attributes. Observed characteristics 331(1) can include zero of more observed characteristics of transaction 301(A). These observed characteristics can include timing information describing when the request and/or response were observed or the like, as described above.

Like transaction 301(A), transaction 301(B) can be a transaction that actually occurred (i.e., an observed transaction). Transaction 301(B) can be of the same transaction type as transaction 301(A), since both transactions included a request that contained command 311. Transaction 301(B) is described by observed attributes 321(2) (which can have values that differ from those attributes observed in the request of transaction 301(A)), observed characteristics 331(2) (which can again differ from those observed for transaction 301(A)), and observed response 341(2) (which can also have a value that differs from the response observed for transaction 301(A)).

In this example, information describing n (an integer number) known transactions of the same type as transactions 301(A) and 301(B) is stored in service model 300. These known transactions are transactions that were either observed or specified by a user. As part of the model building process, information describing an n+1th transaction of the same type has been added to service model 300 by the service model generator. This n+1th transaction, labeled transaction 301(n+1), can describe an “unknown” transaction of a known type of transaction. Such an unknown transactions is of a known type because it has the same command, command 311, as the other transactions of this type. However, unlike the other known transactions of this type, unknown transaction 301(n+1) can be used to respond to requests containing command 311 and “unknown” attributes that do not match those known (i.e., either observed or user-specified) attributes stored for transactions 301(A)-201(n) (not shown). The information describing transaction 301(n+1) thus includes information (e.g., wildcard information) identifying unknown attributes 321(n+1), such that any request that includes command 311 and an attribute that does not match the observed attributes stored for the actual transactions (e.g., such as transactions 301(A) and 301(B)) will match the request information for transaction 301(n+1). The information describing transaction 321(n+1) can also include default characteristics 331(n+1) and default response 341(n+1). These default values can be copied from the corresponding fields of an actual response of the same type.

Information describing another set of transactions of a different type can also be stored within the service model 300 for a particular software component. As shown, m+1 transactions, including transaction 302(A), 302(B), and 302(m+1) of a type of transaction in which the request includes command 312 can be stored in service model 300. Like transactions 301(A) and 301(B), transaction 302(A) can be another observed transaction involving the particular software component. Further, the information describing this transaction can also include the observed command 312, observed attributes 322(1) (if any), observed characteristics 332(1) (if any), and observed response 342(1).

In contrast, transaction 302(B) may be a user-specified transaction. This transaction was thus not observed and did not necessarily ever even occur. Instead, a user entered the information describing this transaction via a user interface. The information describing transaction 302(B) includes command 312, zero or more user-specified attributes 322(2), zero or more user-specified characteristics 332(2), and a user-specified response 342(2). In some embodiments, the user is prompted for entirely new information for each of these user-specified fields. In other embodiments, the user can be allowed to select an existing field (e.g., of another user-specified transaction or of an observed transaction) to copy into one or more of these fields. It is noted that a user can also create a user-specified transaction by modifying information describing an actual transaction. As FIG. 3 shows, user-supplied transaction information can be stored in the same model as transaction information captured by observing actual traffic exchanged between a requester and the service being modeled. In other instances, service models can be generated that are dedicated to user-supplied transaction information while others are dedicated to observed transaction information, among other examples.

Service model 300 can also include information describing an unknown transaction 302(m+1). The information describing transaction 302(m+1) was added to service model 300 after m (an integer number, which does not necessarily have the same value as n) known transactions were described by the model. The information describing this unknown transaction 302(m+1) can be used to handle requests of the same type (e.g., containing command 312) that specify unknown attributes. Accordingly, the information describing transaction 302(m+1) includes command 312, unknown attributes 322(m+1) (i.e., attribute information that will match any attributes not identified in the known attributes stored for the other m transactions of this type), default characteristics 332(m+1), and default response 342(m+1). Further, transactions of an unknown transaction of unknown type (e.g., 303) can also be defined in a service model 300. For instance, the information describing transaction 303 can be used to respond to any request of a type not already described by another row of service model 300. Accordingly, a request containing a command other than commands 311 and 312 could be responded to using the information describing transaction 303, among other examples. As shown, the information describing transaction 303 includes unknown command information 313, which is configured to match any command not already specified in service model 300, unknown attribute information 323, which is configured to match all attributes (if any) associated with unknown commands, default characteristics 333, and a default response 343. As with the default characteristics and responses associated with unknown transactions of known type, transaction 303's default characteristics and response can be user-specified.

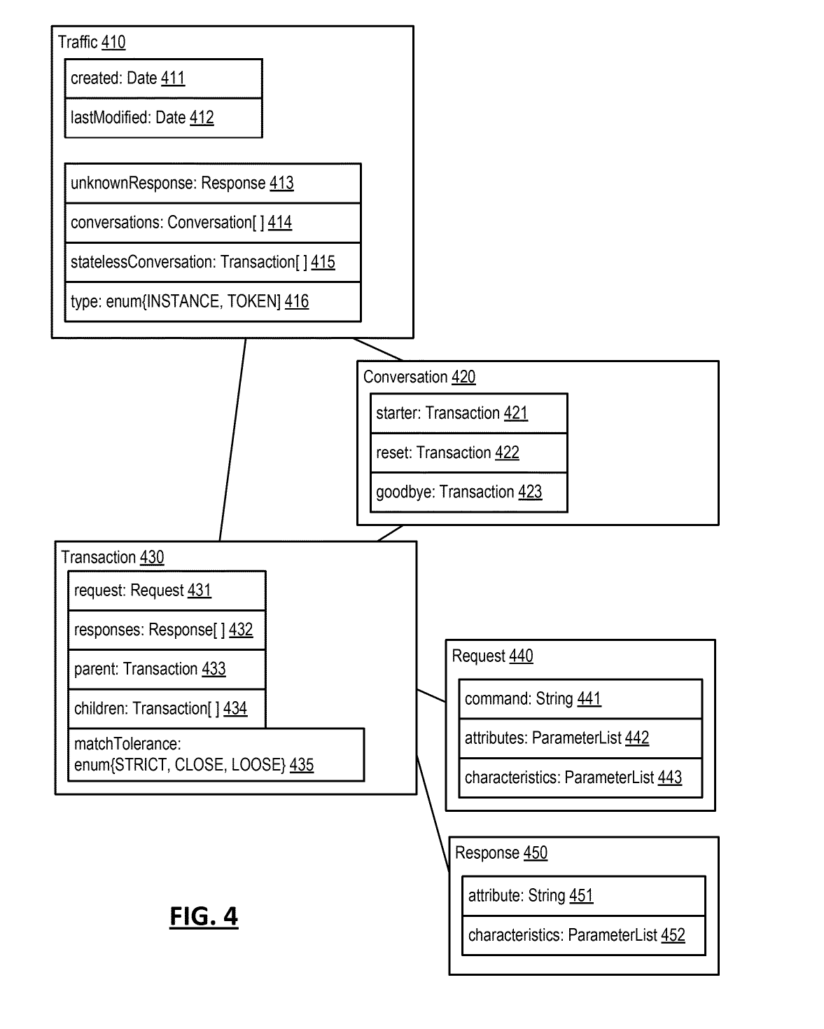

Turning to FIG. 4, a simplified block diagram is shown illustrating representing example features of an example service model for use in virtual services supporting stateful and stateless transactions. Statefulness of a transaction can be identified during monitoring of a transaction, and resulting transaction data can be mined (e.g., using a virtualization engine) to generate a service model supporting the modeling of such stateful transactions. In the example of FIG. 4, a data model is shown that includes five data patterns: traffic pattern 410, conversation pattern 420, transaction pattern 430, request pattern 440, and response pattern 450. Traffic pattern 410 can be used to store information identifying a particular service and the transactions that have been observed or otherwise added to the model of the identified service. Each service model can include a single instance of traffic pattern 410. As shown, traffic pattern 410 includes created field 411, which stores date information identifying when the service model of that particular service was initially created. Traffic pattern 410 also includes lastModified field 412, which stores date information identifying the most recent time at which any of the information in the service model of the particular service was modified.

Traffic pattern 410 can also include an unknownResponse field 413. UnknownResponse field 413 can store information identifying the particular instance of the response pattern that stores information identifying the response to use for unknown transactions of unknown types. Accordingly, in embodiments employing the data pattern of FIG. 4, if an unknown transaction of unknown type is detected by a request processing module, the request processing module will use the response pattern instance identified in unknownResponse field 413 to generate a response.

Traffic pattern 410 includes conversations field 414. Conversations field 414 can identify one or more instances of conversation pattern 420. Conversation pattern 420 stores information representing a set of two or more stateful transactions. Such a set of stateful transactions is referred to herein as a conversation. The instance(s) of conversation pattern 420 identified in conversations field 414 identify all of the observed and/or user-specified conversations for the service being modeled. If the particular service being modeled does not include any stateful transactions (e.g., if a user has specified that the service only performs stateless transactions, or if no stateful transactions have been observed or specified by a user), conversations field 414 will not identify any instances of conversation pattern 420.

Traffic pattern 410 additionally includes statelessConversation field 415. This field can identify one or more instances of transaction pattern 430. Transaction pattern 430 stores information representing a transaction. Each instance of transaction pattern 430 identified in statelessConversation field 415 stores information identifying a stateless transaction that was either observed or specified by a user. StatelessConversation field 415 can identify instances of transaction pattern 430 associated with both known and unknown transactions of known types. If the particular service being modeled does not include any stateless transactions, statelessConversation field 415 will not identify any instances of transaction pattern 430. Type field 416 can store one of two values: INSTANCE or TOKEN that identifies the type of stateful transactions, if any, provided by the service being modeled.

As noted above, conversation pattern 420 stores information identifying a set of stateful transactions. A given service model can include n instances of conversation pattern 420, where n is an integer that is greater than or equal to zero. Conversation pattern 420 can include a starter field 421. This field stores information identifying an instance of transaction pattern 430 associated with a starter transaction. The starter transaction is a transaction that acts as the first transaction in a stateful series of transactions (e.g., a login transaction). In at least some embodiments, all starter transactions are unknown transactions of known type, as will be described in more detail below. The particular transaction type to use as a starter transaction can be specified by a user during the service model configuration process.

Conversation pattern 420 also includes reset field 422. Reset field 422 stores information identifying one or more instances of transaction pattern 430, each of which is associated with a reset transaction (such a reset transaction can be a known or unknown transaction). The value of reset field 422 can be provided by a user (e.g., the user can be prompted to identify the reset transaction(s) for each conversation). A reset transaction is a transaction that, if detected, causes the flow of the conversation to return to the point just after performance of the starter transaction. Conversation pattern 420 also includes a goodbye field 423. This field stores information identifying an instance of transaction pattern 430 associated with one or more goodbye transactions (of known or unknown type) for the conversation. A goodbye transaction is a transaction that causes the conversation to end. To reenter the conversation after a goodbye transaction is performed, the starter transaction for that conversation would need to be reperformed.

Transaction pattern 430 stores information identifying a transaction. Transaction pattern 430 includes request field 431, responses field 432, parent field 433, children field 434, and matchTolerance field 435. Transaction pattern 430 can be used to store stateful and stateless transactions (in some instances, the same transaction can occur both within a conversation and in a stateless situation where no conversation is currently ongoing). Transactions that are always stateless will not include values of parent field 433, children field 434, or matchTolerance field 435.

Request field 431 identifies the instance of request pattern 440 that stores information identifying the request (e.g., by command and attributes) portion of the transaction. Similarly, responses field 432 identifies one or more instances of response pattern 450 that store information identifying the response(s) that are part of that transaction. Each instance of response pattern 450 stores one response attribute (e.g., like those shown in FIG. 2), and thus if responses field 432 identifies multiple response patterns, it indicates that each of the identified response patterns should be used to generate a response when the corresponding request is received.

Parent field 433 stores a value identifying the instance of transaction pattern 430 associated with the transaction that occurs immediately before the current transaction in a conversation. Thus, if transaction pattern 430 stores information identifying the second transaction in a conversation (where the starter transaction is the first transaction in the conversation), parent field 433 can identify the instance of transaction pattern 430 associated with the starter transaction. Similarly, children field 434 can store information identifying each instance of transaction pattern 430 associated with a child transaction of the current transaction. Thus, if transaction pattern 430 stores information identifying the second transaction in a conversation, children field 434 can store information identifying the instance of transaction pattern 430 that stores the third transaction in the conversation. It is noted that children field 434 can identify more than one transaction.

MatchTolerance field 435 can store one of three values: STRICT, CLOSE, or LOOSE. The stored value indicates the match tolerance for a request received immediately subsequent to the current transaction. Strict tolerance indicates, for instance, that, if a conversation is ongoing, the request received immediately after the current transaction is only allowed to match transactions identified in the current transaction's children field 434. If instead close tolerance is specified, the request received immediately after the current transaction can match any of the current transaction's children, as well as any of the current transaction's sibling transactions. Further, if loose tolerance is specified, even more transactions are candidates for matching the next received request, and so on.

Request pattern 440 can include a command field 441, attributes field 442, and characteristics field 443. Each instance of request pattern 440 stores information identifying a particular request. A service model generator can allocate an instance of request pattern 440 for each observed transaction, user-specified transaction, and unknown transaction of known type. Command field 441 stores a string that identifies the command contained in the request. Attributes field 442 can store a parameter list that includes zero or more parameters, each of which represents an attribute of the request. Characteristics field 443 can store a parameter list identifying zero or more characteristics associated with the request. Each parameter in the list can identify a different characteristic. Examples of characteristics can include the time at which the request was sent, the system clock time at which the request was received by the service being modeled, network and/or system conditions that were present when the request was received, and the like. The parameters stored in characteristics field 443 can be used to generate time sensitive values, as well as to model actual conditions such as response timing and availability window, among other examples.

Response pattern 450 can include an attribute field 451 and a characteristics field 452. Attribute field 451 stores a string that represents a response attribute. As noted above, a given transaction can have multiple response attributes (e.g., responses field 432 of transaction pattern 430 can identify multiple instances of response pattern 450), and thus generating a response can involve accessing multiple response patterns in order to include the string identified in each of the response patterns' attribute field 451 in the response. Attribute field 451 can store a user-specified or observer response attribute, as well as values, like request sensitive values and time sensitive values, generated by the service model generator. Characteristics field 452 can store a parameter list containing zero or more parameters. Each parameter can identify a characteristic of the response, such as the system clock time when the response was sent to the requester by the service, network and/or system conditions that were present when the response was sent, and the like.

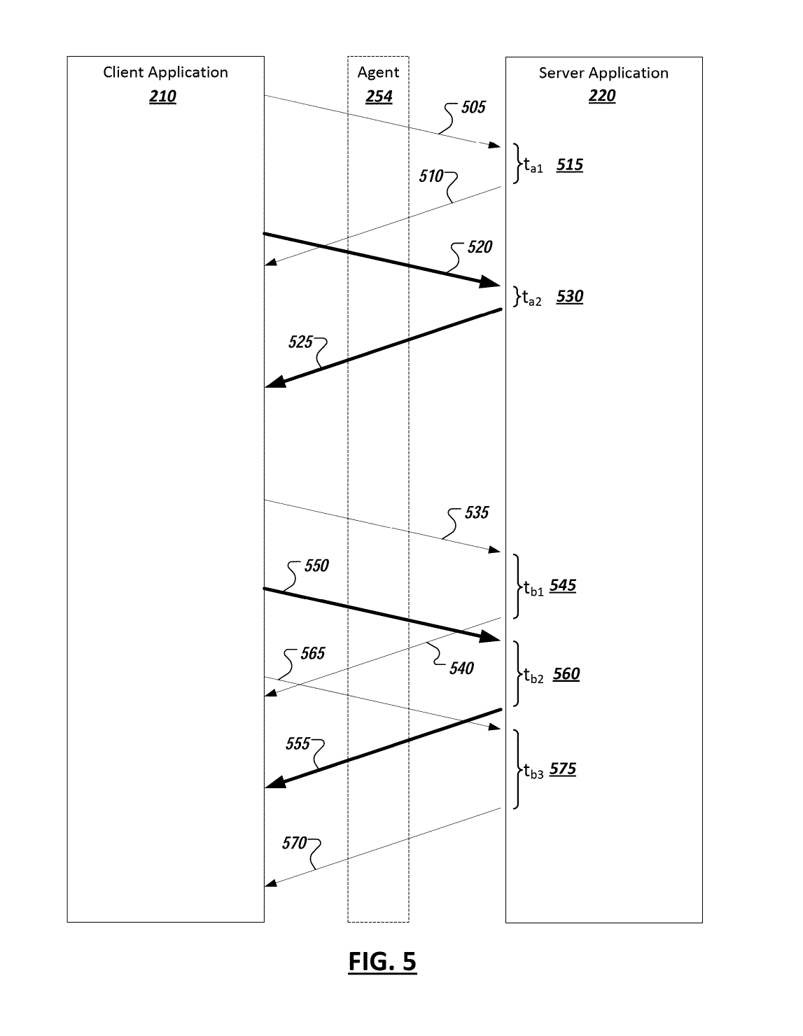

Turning now to FIG. 5, a simplified flow diagram is shown illustrating transaction between a client (or requester) application 210 and a server application 220. Application 210 may only be a “client” or requester within the context of this particular example transaction. Similarly, application 220 may only be a “server” or responder within this particular transaction. Indeed, in other transactions, application 210 can be the server and application 220 the client, among other examples. In the particular example of FIG. 5, an agent 254 can be provided, such as an agent implemented in connection with application 210, that can be configured to logically insert itself within a communication pathway between application 210 and application 220. The agent can identify requests and responses communicated between the applications 210, 220. The agent, or other monitoring tools, can be further configured to observe and collect information describing performance of the applications 210, 220 during the transactions. Such information can include response time information for service application 220.

In the particular example of FIG. 5, a first set of transactions including requests 505, 520 and responses 510, 525 is shown during a first span of time. The first set of transactions can be observed transactions observed during live operation of applications 210, 220 within an operational environment. Further, response times 515, 530 can identified for the server application's respective responses 515, 530 to requests 505, 520. Additionally, a second set of transactions is also represented in FIG. 5, showing requests 535, 550, 565 and responses 540, 555, 570 observed over a later period of time within the operational environment. In one example, the second set of transactions may have been observed during a period when server application 220 faced increased traffic, client requests, load, etc. Accordingly, as shown in the example of FIG. 5, the resulting response times 545, 560, 575 of the server application 220 during this busier second period, may be observed to be longer than those (515, 530) observed during a period when a lower load or volume of traffic was being handled by the server application 220.

In some instances, the delays experienced by a client application 210 resulting from response times 515, 530, 545, 560, 575 of server application 220 can affect the performance of client application 210 (as well as other systems dependent on responses provided by client application 210 based on responses (e.g., 515, 530, 540, 555, 570) received from server application 220. Among other example, in instances where a user desires to test (or develop) an application (e.g., 210) against the various loads and response characteristics of server (e.g., 220), virtual services may be used together with performance data representing variable performance characteristics (including varying response times (e.g., 515, 530, 545, 560, 575) to facilitate such testing.

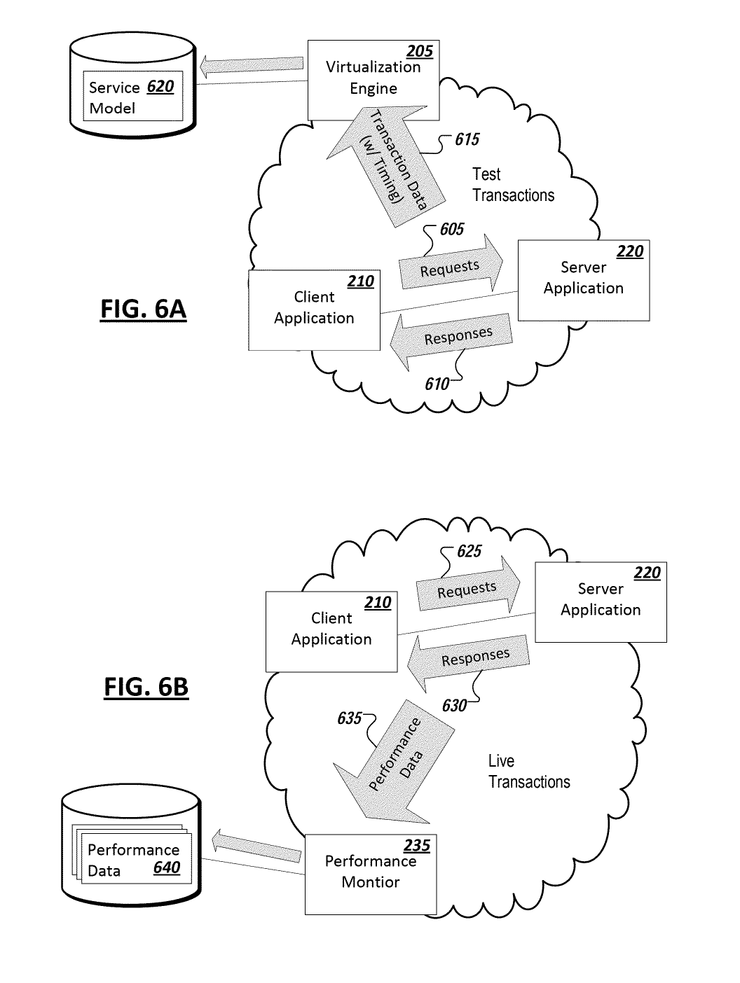

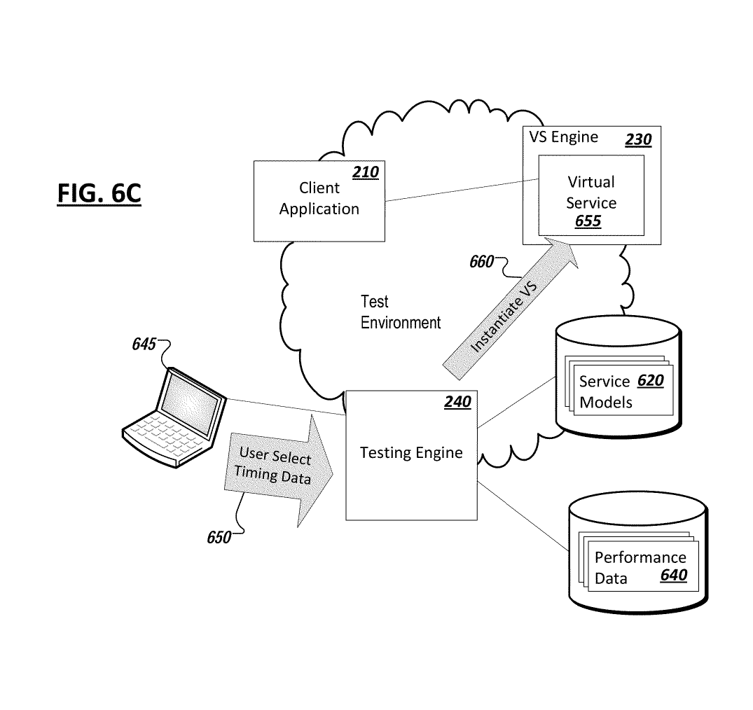

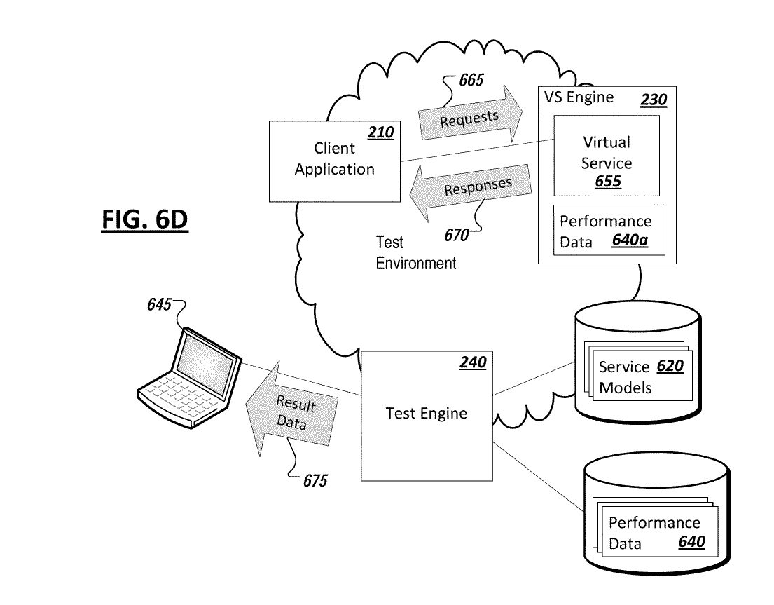

Turning to the examples of FIGS. 6A-6D, simplified block diagrams are shown illustrating the utilization of performance data in connection with a virtual service modeling a particular server application (e.g., 220). In FIG. 6A, requests 605 of a client application 210 and responses 610 by the server application 220 are detected (e.g., using an agent) and information describing these requests 605 and responses 610 are collected and communicated as service data 615 to a virtualization engine 205. The virtualization engine 205 can then use this information to define a service model 620 for the server application 220 that models the various transactions, including requests 605 (or requests of the type(s) of requests 605) and real-world server application's 220 observed responses 610 to these requests 605.

In some implementations, the requests 605 and responses 610 in the example of FIG. 6A may be captured within a controlled environment provisioned for the development of a virtual service corresponding to a particular server application 220. Such an implementation can be desirable in some cases, so as to allow a client application 210 unfettered access to the server application 220 so that a complete (or substantially complete) set of transaction data can be developed for use in generating service model 620. While the transaction data 615 collected from the “test” transactions can be sufficiently comprehensive to allow for a robust service model 620 to be generated as well as certain performance characteristics of the server application 220 to be defined, performance characteristics of the server application 220 observed in a controlled transaction environment may not reflect the performance characteristics of a live deployment of the server application 220. Further, even in instances where requests 605 and responses 610 were observed in a live, operational environment, transaction data 615 captured for the transactions may only identify a limited subset of the potentially diverse variations in performance by the server application 220 (such as illustrated in the example of FIG. 5).

While transaction data 615 can include information that can be used to define and model certain default server application performance characteristics, other sources can be mined for additional performance information for the server application 220. Turning, for example, to FIG. 6B, additional requests 625 and responses 630 can be monitored between client applications (e.g., 210) and server application 220 and performance data can be collected describing the performance of the server application 220, including response times of the server application 220. Performance information (e.g., 630) for such additional requests 625 and responses 630 can be captured during live transactions, including transactions involving requests originating from multiple different client applications transacting with the server application 220 over a period (or several periods) of time. Additionally, performance information can be detected, collected, and aggregated as performance data 640 from multiple different monitors, systems, and tools collecting such information. Consequently, performance data 640 can reflect a more comprehensive and real-world representation of the performance characteristics of a server application 220 when fielding various types of client requests 625. Performance data 640 can be further improve modeling of a particular server application 220 d by obtaining additional performance information reflecting how the type and content of a request can impact the response time of the server application 220. Indeed, response time of a server application can be at least somewhat dependent on the type of request, and therefore also the type of response to be generated by the server application 220.

Still further, by collecting performance data 640 over a variety of different periods of operation (in some cases continuously over long spans of time (e.g., months, years)), trends can be identified in the server application's 220 performance. For instance, patterns can be identified that indicate that server application's performance degrades (e.g., response times increase) or otherwise fluctuates at certain times of day (e.g., lunch time, evenings, etc.), on certain days of the week or year (e.g., Cyber Monday), or in response to particular events, including events internal to the server application (e.g., a maintenance event, diagnostic tasks, etc.) or external (e.g., such as a promotion driving traffic to the server application, a high-profile news event, weather fluctuation, etc.). In some implementations, the context of the response times and other performance characteristics identified for a server application 220 can also be included in performance data 640. Such information can be used, for instance, to assist users in identifying particular performance data for use with an execution of the corresponding virtual service, such as particular performance data to use in a test of a client server (e.g., 210) that interfaces with the server application 220, among other examples.

Accordingly, as shown in the example of FIG. 6C, a user (e.g., at user device 645) can cause a particular virtual service 655 to be instantiated 660 from a particular virtual model 620 describing aspects of the operation of a particular server application (e.g., 220). For instance, in one example, a user can use testing engine 240 to build a test case or select an existing test case that involves testing of a client application 210. The test case can include virtualization of the server application (e.g., 220) through automatic instantiation 660 of virtual service 655 using virtual service engine 230. A test case can be constructed through user interfaces provided for display on user device 645 allowing a user to select a particular server application (e.g., 220) to be included in a test of client application 210. Selection of the particular server application can prompt identification of a corresponding service model 620 for the particular server application. In some implementations, if it is determined that a selected particular server application lacks a corresponding service model, the selection of such a server application can prompt a service model to be generated for the particular server application (e.g., from related transaction data or monitoring of the particular server application, etc. using a virtualization system).

In addition to selection of a virtual service to be instantiated, for instance, through selection of a particular test that automatically instantiates the virtual service 655, a user may be able to select (e.g., 650) particular performance characteristics that are to be applied by the virtual service 655 during its execution. In one example, selection of a particular server application (e.g., 220) to be virtualized can cause a listing of performance data 640 to be presented to a user that shows available performance data that has been generated for or collected from observation of the selected server application. In other examples, certain performance data 640 can be generalized performance data that can be applied to multiple different virtual services modeling multiple different software components, among other examples.

As noted above, performance data can be consumed in some implementations of a virtual service (or virtual service engine) allowing user-defined or observed performance characteristics to be supplied and used by a virtual service 655 to model operation of a server application (e.g., 220) exhibiting such performance characteristics. A user can be presented with a user interface (e.g., on user device 645) that permits the user to view available performance data that can be applied, which the user can select to have applied during execution of the virtual service 655. In other instances, a user can select or build a particular test case (e.g., using testing engine 240) that includes not only instantiation of the virtual service 655 but also automated selection of certain performance data 640 to be applied during execution of the virtual service 655, among other potential examples and implementations.

Turning to FIG. 6D, upon selection of a virtual service 655 (or a request to virtualize a particular software component modeled by the virtual service 655) and identification of particular performance data (e.g., 640a) to be applied during execution of the virtual service 655, virtual service 655 can be instantiated and run to apply the particular performance data 640a in a virtual service environment. A client application (e.g., 210) can interact with the virtual service 655 as if the virtual service were the server application (e.g., 220) modeled by the virtual service. For instance, client application 210 can send requests 665 to the virtual service 655. The virtual service 655 can identify parameters of the requests, including operations and attributes included in the request 665, and identify (e.g., from a corresponding service model 620) how it is to generate a response 670 to the request 665 that would be consistent with how the modeled server application (e.g., 220) would respond. Generation of the modeled response 670 by the virtual service 655 can be further tailored to simulate performance characteristics of the modeled server application (e.g., 220) as described in the particular performance data (e.g., 640a). For example, if the particular performance data 640a indicates that the modeled server application would take a particular duration of time to generate a particular response to a first type of request, the virtual service can delay or otherwise time its response so as to model this particular response time. Different response times can be defined for responses for other types of requests as well as requests of the first type that possess different (and potentially more involved) attributes, among other examples. Further, if the selected particular performance data 640a describes a trend in the performance of the modeled server application over time, the virtual service 655 can model its responses 670 accordingly so as to similarly model these changes in performance characteristics over time, among other examples.

As noted above, the use of a virtual service (e.g., 655) applying particular performance data (e.g., 640a), such as response time data, can be useful in tests of other software components (e.g., 210) that make use of the modeled server application, such as in a load test. In the example of FIG. 6D, a testing engine 240 managing a particular test can possess additional functionality to assess the performance of the client application 210 interfacing with the virtual service 655 in the test and generate test results 675 in response to the test. The test results 675, among other features, can identify how the client application 210 responded to a virtual service exhibiting particular performance characteristics that might be observed in actual operation with the modeled server application (e.g., 220). Such result data can be provided to the user (e.g., for display on user device 645). The user can utilize information in the result data 675 to generate additional tests, select or modify the set of performance data 640 applied by the virtual service, among other examples.

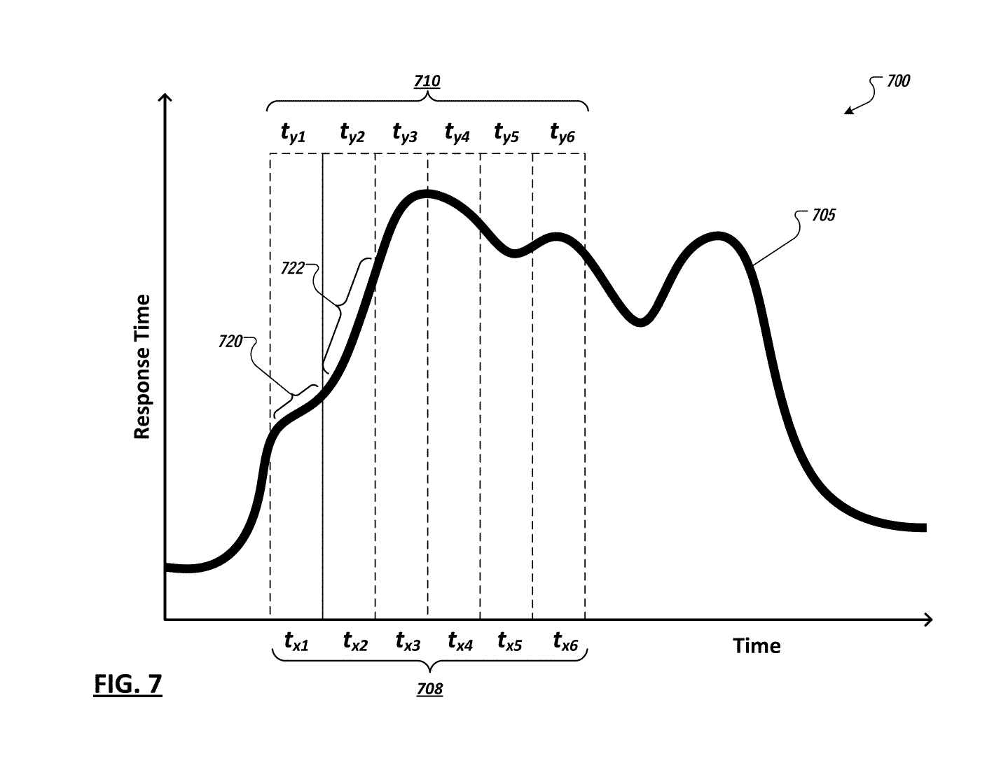

Turning to the example of FIG. 7, a graph 700 is shown illustrating a response time of a particular software component over a period of time (e.g., hours, days, months, etc.). In some instances, the response time curve 705 illustrated can correspond to the response time for responses by the particular software component to a particular type or form of request. In other instances, the response times 705 can correspond to a general response time by a particular software components to any request, among other examples. In still other examples, response times 705 may not be software-component-specific and can represent generic response times that could be adopted by any hypothetical software component, among other examples.

As noted in previous examples, in some instances, a user can select particular performance data that describes performance aspects of the particular software component, including response times of the particular software component. In one example, a user can select a particular time range or span (e.g., 708) for which corresponding performance data has been gathered and is available. For instance, a user may be interested in applying performance data indicating the progression of average response times of a particular software component from 10:00 am to 11:00 am (or some other span of time). Applying such data can cause the virtual service to model the patterns of the particular software component's response times over this time span, among other uses.

In some implementations, a user may choose to simulate performance of a software component over a particular span of time 708 using a corresponding virtual service and performance data describing performance characteristics of the software component over the particular span of time 708. In some instances, however, a user may not have the time or desire for a simulation that runs the full duration of the selected time span (e.g., 708) to be modeled. For example, a virtual service can be run to simulate performance of a software component that has been observed over an entire day. Corresponding performance data can be identified that identifies how performance of the software component varies (e.g., such as with curve 705) over the course of twenty-four hours. However, the user may wish to simulate the span of an entire day within a test duration (e.g., 710) of only thirty minutes (or some other duration), among other examples.

As shown in the example of FIG. 7, time intervals tₓ can each correspond to a subunit of time of an overall span 708. For instance, to continue with the example of the previous paragraph, span 708 can correspond to a portion of a day and intervals tₓ can correspond to a single hour in the day. Corresponding intervals t_{y} can represent that portion of the abbreviated test span that correlates to the real duration of time to be simulated. For instance, in the previous example, if a test simulating an entire day is to have a duration of thirty minutes, then each interval t_{y} can correspond to a modeled hour tₓ and thus be equal to 1/48^{th} of an hour (or one minute and fifteen seconds of the overall test). Accordingly, a virtual service can utilize performance data to emulate performance 720 of a software component over a one hour period tₓ₁ for one minute and fifteen seconds (i.e., the period t_{y1}) before proceeding to a next portion 722 of performance data corresponding to tₓ₂ to be emulated by another one minute and fifteen second span t_{y2}, and so on. Further, results can be collected during each period t_{y} to identify how the corresponding performance of the modeled software component affects another process or component, among other analyses.

In one example, transaction data can identify a series of transaction examples and response times over a particular portion (e.g., 720, 722) of a software component performance (e.g., 705) over a span. Modeling of these portions (e.g., 720, 722) of a performance curve can involve having a corresponding virtual service generate responses according to each of the example response times over the modeled portion of the span (and in some cases repeating at least some of the response times identified for a real world software component during this span), such as in instances where the duration of the simulation correlates, is substantially equal to, or exceeds the real world span being modeled. Accordingly, a virtual service may be able to simulate responses that adopt each of the response times defined for the portion of the span in corresponding performance data. In other instances, a virtual service may only sample from the complete set of result time data points captured in and available in transaction data, such as when a span (e.g., t_{y1}) is shorter than the actual span (e.g., tₓ₁) being modeled. For instance, if an abbreviated test span t_{y} only allows for simulation of three responses, but twenty observed response times were captured and defined in performance data for the corresponding real world span tₓ, then a virtual service can select three of the twenty available response times and apply these selected three response times to the three responses or transactions in test span t_{y}, among other examples.

In other instances, an average response time can be determined for various portions (e.g., tₓ) of a span 708 and the average response time can be applied to a virtual service during the corresponding test duration (e.g., t_{y3}). Accordingly, the virtual service can apply performance data to generate responses during a test duration (e.g., t_{y3}) that repeat the average response time determined for a corresponding real world span (e.g., tₓ₃) until a new span (e.g., real world span tₓ₄) is to be modeled with its own distinct average response time, among other examples. In either implementation, a user can not only control which performance characteristics are adopted by a virtual service at runtime, but a user can further control when and how long such performance characteristics are to be applied. For instance, performance characteristics can be applied in a simulation that are divorced from the real world duration in that they are exhibited by the virtual service for a shorter or longer period than observed for a real world software component being modeled by the virtual service.

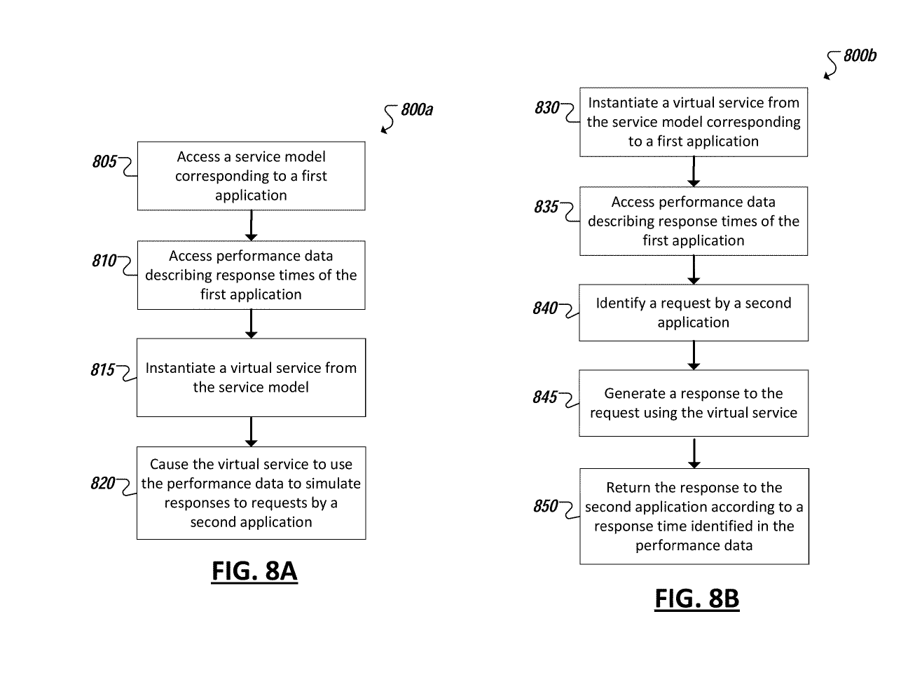

FIG. 8A is a simplified flowchart 800a illustrating an example technique for varying performance characteristics used by a virtual service at runtime. For instance, a service model can be accessed 805 that corresponds to an application or other software component. Performance data can also be accessed 810, the performance data describing response times of the application. In some instances, accessing performance data 810 can include selection of particular performance data in response to a user instruction received through a graphical user interface. A virtual service can be caused to be instantiated 815 using the service model. The virtual service can be provided with the performance data and use 820 the performance data to simulate responses in accordance with the performance characteristics described in the performance data, including the response time for generating the responses, among other examples. In some instances, the performance can be incorporated in the instantiation of the virtual service. In other instances, the performance data can be provided for consumption by the virtual service (or a virtual service engine executing the virtual service) to cause the virtual service to tailor its performance to the characteristics included in the performance data, among other examples.

FIG. 8B is a simplified flowchart 800b illustrating an example technique associated with a virtual service's use of performance data. For instance, a virtual service can be instantiated 830 and performance data can be accessed 835 that describes various performance characteristics of the software component to be modeled by the virtual service. A request can be identified 840 that is directed to the virtual service and a response can be generated 845 by the virtual service to the request. The response can be returned 850 so as to simulate performance of the modeled software component. This can include returning 850 the response so as to model a response time for the response, among other examples. For instance, in some examples, a real world span of time corresponding to a real software component can be modeled or simulated by the virtual service over a span of time shorter than the real world span. This can allow a test or other tool to obtain a snapshot of the effects of such performance characteristics without having the simulation track the real observed performance of the modeled software component over a span of time equal to the real world span, among other potential examples and benefits.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
accessing performance data, wherein the performance data describes a response time of a first software component to a particular request of another software component;
instantiating a virtual service, wherein the virtual service is to simulate operation of the first software component; and
causing the virtual service to generate responses to requests received from a second software component based on the performance data.

2. The method of claim 1, further comprising accessing a service model corresponding to a first software component, wherein the virtual service is instantiated based on the service model.

3. The method of claim 2, wherein service model is based on a plurality of requests of the first software component and a plurality of responses of the first software component to a plurality of requests by other software components as captured during monitoring of transactions involving the first software components.

4. The method of claim 3, wherein the plurality of responses were captured in a first span of time.

5. The method of claim 4, wherein the transactions comprised transactions in a test environment.

6. The method of claim 4, wherein the performance data corresponds to operation of the first software component in a different, second span of time.

7. The method of claim 6, wherein the service model describes performance characteristics of the first application, the virtual service is configured to simulate operation of the first application in accordance with the performance characteristics, and the performance data is applied to cause the virtual service to deviate from the performance characteristics described in the service model.

8. The method of claim 1, wherein the performance data is captured in an operational environment and is based on performance of the first software component in generating a plurality of responses to a plurality of requests from other software components, wherein the plurality of responses of the first software component comprise the particular response and the plurality of requests comprise the particular request.

9. The method of claim 8, wherein the performance data is captured by a performance monitor monitoring the first software component in the operational environment.

10. The method of claim 1, wherein the performance data describes response times for responses by the first software component to requests from other software components over a particular span of time, wherein the responses times in the span of time correspond to a plurality of responses of the first software component to a plurality of requests by other software components.

11. The method of claim 10, wherein accessing the performance data comprises selection of a particular subset of the performance data of the particular span of time corresponding to a subset of the plurality of response in a sub-span of the span of time.

12. The method of claim 11, wherein the selection corresponds to a sub-span corresponding to a particular time of day.

13. The method of claim 11, wherein the selection corresponds to a sub-span corresponding to a particular calendar date.

14. A method comprising:
instantiating a virtual service to model operation of a first software component;
accessing performance data, wherein the performance data describes response times of the first software component to requests of other software components;
identifying a request sent to the virtual service by a second software component;
generating a response to the request using the virtual service; and
causing the response to be returned to the second software component, wherein the response is returned according to a particular one of the response times of the first software component.

15. The method of claim 14, wherein the virtual service is instantiated based on a service model identifying a plurality of responses by the first software component to a plurality of requests of the first software component by other software components.

16. The method of claim 14, wherein each response time corresponds to a duration of time for the first software component to generate a respective response to a respective request.

17. The method of claim 14, wherein:
accessing the performance data comprises identifying selection of a particular subset of the performance data corresponding to a particular span of time comprising a plurality of responses of the first software component to a plurality of requests by other software components,
a series of requests are identified, and
a series of responses to the series of requests are generated by the virtual service using the performance data to simulate progressive responses times by the first software component over the particular span of time.

18. The method of claim 17, wherein the virtual service generates the series of responses simulating progressive responses over an abbreviated span of time relative to the particular span of time.

19. The method of claim 14, wherein the virtual service is configured to generate a stateful response to a particular type of request.

20. The method of claim 14, wherein the virtual service is configured to recognize parameters of requests and generate responses based on the parameters.

21. The method of claim 20, wherein the parameters comprise an operation of a respective request and attributes corresponding to the operation.

22. The method of claim 14, wherein the virtual service is instantiated in a virtual service environment.

23. The method of claim 22, wherein the virtual service environment comprises a cloud-based virtual machine.

24. The method of claim 14, wherein accessing the performance data comprises identifying a user selection of the performance data from a repository of performance data.

25. The method of claim 24, wherein the user selection comprises user selection of performance data from a set of performance data identified for transactions involving the first software component.

26. A computer program product comprising a computer readable storage medium comprising computer readable program code embodied therewith, the computer readable program code comprising:
computer readable program code configured to access performance data, wherein the performance data describes a response time of a first software component to a particular request of another software component;
computer readable program code configured to instantiate a virtual service from the service model, wherein the virtual service simulates operation of the first software component; and
computer readable program code configured to cause the virtual service to generate responses to requests received from a second software component based on the performance data.

27. A system comprising:
a processor device;
a memory element; and
a virtual service manager to:
access performance data, wherein the performance data describes a response time of a first software component to a particular request of another software component;
instantiate a virtual service to simulate operation of the first software component; and
cause the virtual service to generate responses to requests received from a second software component based on the performance data.

28. The system of claim 27, further comprising a test engine to manage a test of transactions involving the first and second software components, wherein the virtual service is to model the first software component during the test.

29. The system of claim 27, further comprising a performance monitor configured to:
capture response times of responses generated by the first software component to requests of other software components; and
generate performance data from the captured response times.

30. The system of claim 27, further comprising a repository of a plurality of service models, wherein the virtual service is instantiated from a particular one of the plurality of service models that models requests and responses identified for the first software component.
